(19) United States
(12) Patent Application Publication
(10) Pub. No.: US 2014/0172994 A1
(43) Pub. Date: Jun. 19, 2014

(54) PREEMPTIVE DATA RECOVERY AND RETRANSMISSION

(71) Applicants: Martin RAUMANN, San Francisco, CA (US); Leonardo Martins, London (GB)

(72) Inventors: Martin RAUMANN, San Francisco, CA (US); Leonardo Martins, London (GB)

(21) Appl. No.: 13/715,853

(22) Filed: Dec. 14, 2012

(51) Int. Cl. H04L 12/58

(52) U.S. Cl. CPC H04L 51/30
USPC 709/206

(57) ABSTRACT

A data transfer mechanism including at least one data buffer through which messages are sent from a message sender to a message receiver, a preemptive recovery mechanism, and a preemptive retransmission mechanism. The preemptive recovery mechanism and the preemptive retransmission mechanism include at least portions of a control data path, an event handler, a processor, and a cache. The preemptive recovery mechanism sends an early warning message to the message sender independently of the message receiver upon detection that the data buffer is nearing overflow. The preemptive retransmission mechanism sends a retransmission request on behalf of the receiver to the sender, independently of the message receiver, upon detection that the receiver's data buffer has overflowed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure relates to broker-less high-throughput, low latency application data transfers using preemptive data recovery and/or retransmission.

### SUMMARY

Aspects of the subject technology include or are part of a data transfer mechanism. The mechanism includes at least one data buffer through which messages are sent from a message sender to a message receiver, a preemptive recovery mechanism, and a preemptive retransmission mechanism. The preemptive recovery mechanism and the preemptive retransmission mechanism include at least portions of a control data path, an event handler, a processor, and a cache. The preemptive recovery mechanism sends an early warning message to the message sender independently of the message receiver upon detection that the data buffer is nearing overflow. The preemptive retransmission mechanism sends retransmission request messages on behalf of the receiver. The retransmission request may be built from the data that was originally going to the receiver, but that was dropped due to a buffer overflow.

Some aspects of the subject technology include either the preemptive recovery mechanism or the preemptive retransmission mechanism. Other aspects include both mechanisms and possibly other data recovery and/or retransmission mechanisms.

In some examples, the preemptive recovery mechanism operates by having the event handler cause the processor to effect sending of the early warning message to the message sender. Likewise, in some examples, the preemptive retransmission mechanism operates by having the event handler cause the processor to effect sending a retransmission request on behalf of the receiver to the message sender. The mechanisms can operate in other ways as well.

This brief summary has been provided so that the nature of the invention may be understood quickly. A more complete understanding of the invention may be obtained by reference to the following description in connection with the attached drawings.

### BRIEF DESCRIPTION OF THE DRAWINGS

FIG. 1 shows a block diagram illustrating logical connectivity between major hardware components according to some aspects of the present disclosure.

FIG. 2 shows a logical view of an early-warning congestion message design according to some aspects of the present disclosure.

FIG. 3 shows a logical view of a fast NAK design according to some aspects of the present disclosure.

FIG. 4 shows a logical view of a preemptive data retransmission design according to some aspects of the present disclosure.

### DETAILED DESCRIPTION

Some traditional network switches have low-powered embedded CPUs used only for controlling the switch fabric. One weakness of such devices is the lack of bandwidth between the CPUs and the switch fabric, as well as the lack of computing power and memory in the CPUs to run complex applications. Some network switches are also limited in what they can do when congestion is found in the system. Often the only option is to pause a sender's port from sending in any more data. Lastly, some network switches handle lost packets by simply increasing a packet count.

Certain server switches focus on experimental protocols and do not really focus on the specific use case of fast-tracking recovery by accelerating retransmission requests within existing protocols.

Some current middleware solutions that use reliable multicast protocols suffer from high-latency when data is lost and needs to be recovered. These solutions often rely on negative acknowledgements (NAKs) coming from a receiving application whenever the application detects that data is lost. NAKs are sent all the way to the original sender, which then has to re-publish the lost data, causing impact both on the publisher and receivers. In addition, the receivers may need to de-duplicate the data. Excessive NAKs in the environment may also cause NAK storms, where a slow consumer can cause other normal receivers to also lose data due to excessive de-duplication of normal traffic. These, in turn, will also send more NAKs to the sender, which will then re-send even more data, eventually causing a NAK storm.

Aspects of the present technology attempt to address the foregoing by providing a broker-less hardware appliance to host a combination of low-latency and high-throughput data-centric applications that communicate over an Ethernet switched fabric. Examples of such applications include but are not limited to market data feed handlers, financial risk and compliance checks, message-oriented middleware applications, distributed data caches, telemetry data stream handlers from satellites, command and control data streams, and sensor data collection in manufacturing.

In some aspects, the hardware appliance may be able to recover application data faster than traditional methods by generating fast NAKs or retransmission requests on behalf of the receiving application or by re-sending dropped packets. Additionally, early-warning congestion messages may be sent to publishing applications to prevent data loss in the first place.

Briefly, aspects of the subject technology include or are part of a data transfer mechanism. The mechanism includes at least one data buffer through which messages are sent from a message sender to a message receiver, a preemptive recovery mechanism, and a preemptive retransmission mechanism. The preemptive recovery mechanism and the preemptive retransmission mechanism include at least portions of a control data path, an event handler, a processor, and a cache. The preemptive recovery mechanism sends an early warning message to the message sender independently of the message receiver upon detection that the data buffer is nearing overflow. The preemptive retransmission mechanism sends retransmission request messages on behalf of the receiver. The retransmission request may be built from the data that was originally going to the receiver, but that was dropped due to a buffer overflow.

Some aspects of the subject technology include either the preemptive recovery mechanism or the preemptive retransmission mechanism. Other aspects include both mechanisms and possibly other data recovery and/or retransmission mechanisms.

In some examples, the preemptive recovery mechanism operates by having the event handler cause the processor to effect sending of the early warning message to the message sender. Likewise, in some examples, the preemptive retransmission mechanism operates by having the event handler cause the processor to effect sending of the lost one of the messages from the cache to the message sender. The mechanisms can operate in other ways as well.

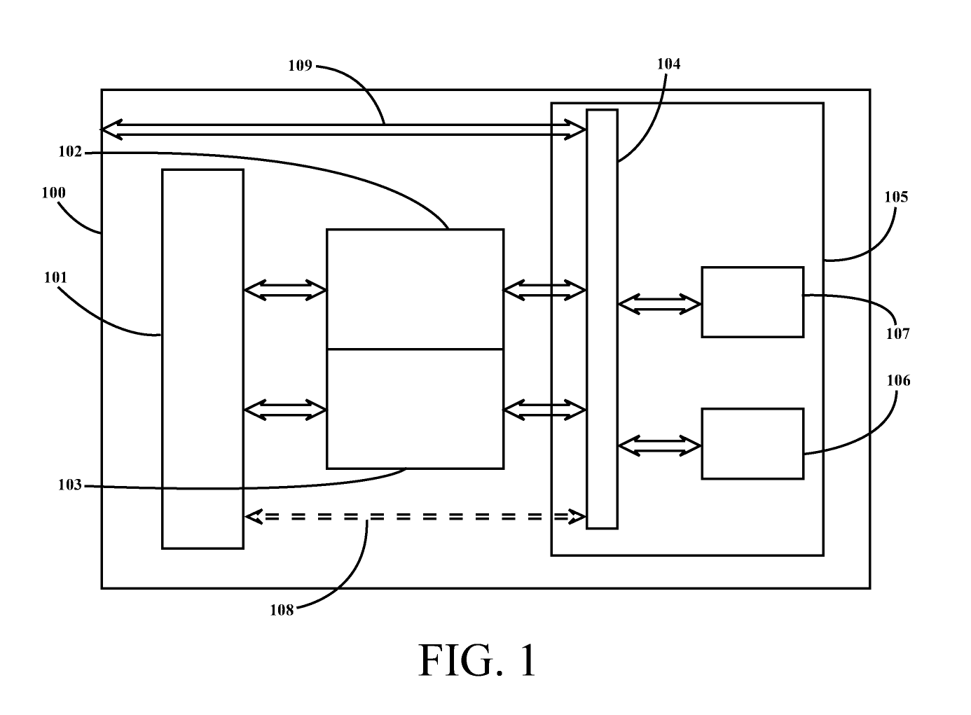

FIG. 1 shows a block diagram illustrating logical connectivity between major hardware components according to some aspects of the present disclosure. Appliance 100 may be highly modular, allowing hardware upgrades (e.g. new CPUs with different pins, or different network switch chips) without having to fully re-design the system. Three boards are interconnected to form each module in FIG. 1:
The switch-fabric board 101 hosts connectors to the physical network connections.
The mezzanine boards 102 and 103 host any chip(s) capable to interconnect the data bus and the switch fabric. This enables customers to have customized hardware designed for specific purposes (e.g. trading applications hosted in FPGAs, or network processors) hosted in the appliance. It also allows storage devices to be added to record data within the appliance itself.
The CPU board 105 hosts powerful CPUs 106 and 107, memory, and one or more data busses 104. The CPUs may be dedicated to recovery and/or retransmission of application data or may also perform other functions. CPUs 106 and 107 may also be implemented as FPGAs, GPUs, or other types of processors.

The switch control data path 108 between the data buses 104 and the switch-fabric board 101 serves to both control and send low latency packets to/from the CPUs 106 and 107. The data path 109 between the data bus 104 and the outside of the appliance serves to carry a low-latency, high-throughput data to the CPUs 106 and 107.

In other aspects, different arrangements of chip(s), CPU(s), portion(s) of CPU(s), other processors such as but not limited to GPUs or FPGAs, portions of those processors, one or more busses, and/or one or more data paths can be used to implement the subject technology. The subject technology is not limited to these components, which are provided by way of example.

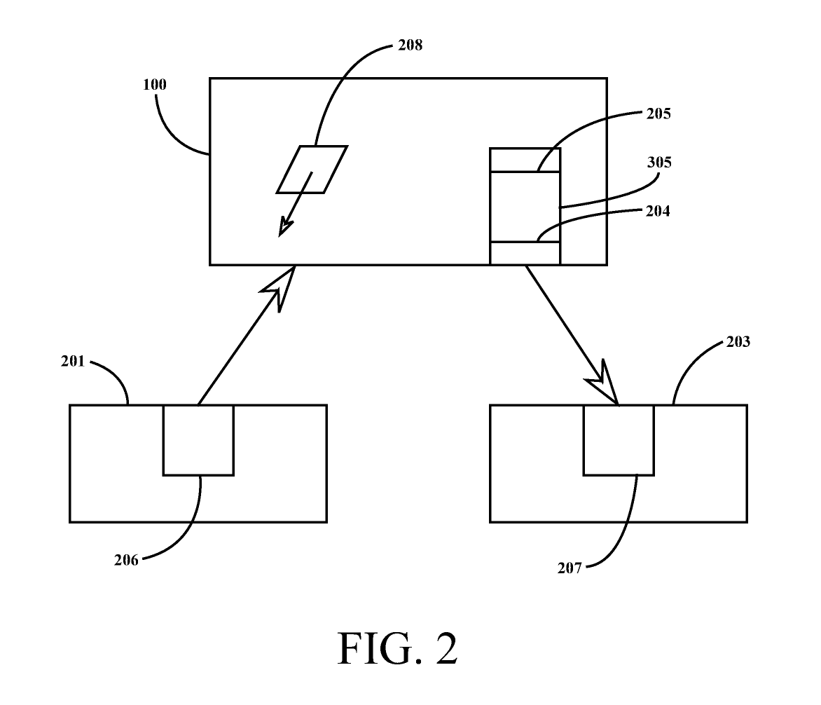

In general, FIGS. 2, 3 and 4 show a possible design of an early-warning congestion message, a fast NAK, and preemptive recovery mechanisms according to some aspects of the subject technology. The sender host 201 is connected to the appliance 100. The receiver host 203 consumes the messages sent by the sender host 201, and is also connected to the appliance 100. Applications running inside the sender host 201 may have a network buffer 206; similarly, applications running inside the receiver host 203 may have a network buffer 207. The appliance 100 also has an egress buffer 305 with a high watermark 205, and a low watermark 204. These watermarks may represent the physical size of the buffer, the TCP/IP window size of a TCP/IP session, the number of TCP/IP retransmissions, the number of SYNs (connection requests) coming from a given connection, or any other counters that affect the quality of service of a connection.

FIG. 2 shows a logical view of an early-warning congestion message design according to some aspects of the present disclosure. In FIG. 2, an early-warning congestion message 208 is sent directly to the sending host 201 if the high watermark 205 is reached, and a clear message 208 is also sent directly to the sending application running on sender host 201 if the low watermark 204 is reached. Early-warning congestion message 208 may also be sent if the TCP/IP window size of a TCP session decreases below a predetermined or dynamically set threshold. The early warning message is sent independently of any action by a message receiver according to aspects of the subject technology.

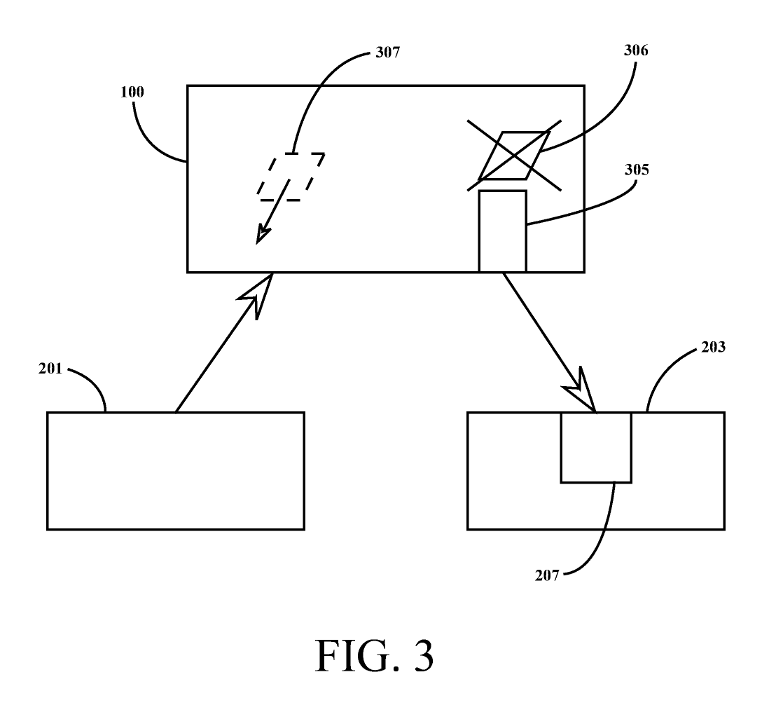

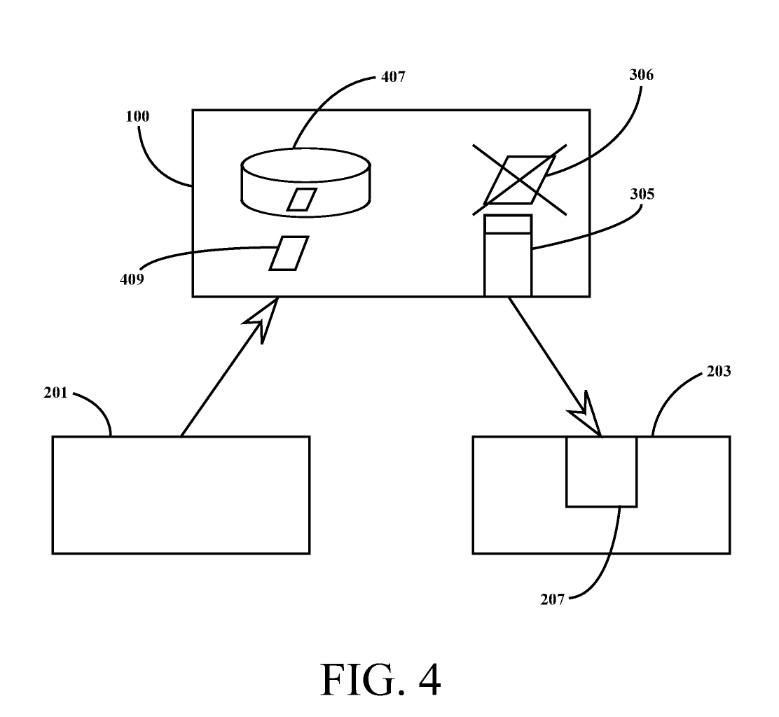

FIGS. 3 and 4 show that a full network buffer 207 can cause network buffer 305 to fill up and data message 306 to be dropped. FIG. 3 shows that fast NAK 307 can be sent from the appliance 100 directly to the sending application running on sender host 201. If data message 306 is a part of a TCP/IP session, fast NAK 307 may also be a TCP retransmission request sent to the sending application running on sender host 201. FIG. 4 shows that an alternative to recovering the lost message, a copy of the data message 306 can be sent to a memory cache 407. Preemptive resend message 409 can then be read from the cache and resent to egress buffer 305 when it is drained. If data message 306 is a part of a TCP/IP session, preemptive resend message 409 may be a TCP fast retransmit.

In more detail, still referring to FIGS. 1 to 4, aspects of the subject technology provide several possible techniques for appliance 100 to speed up the recovery of lost data message 306:

The fast NAK recovery mechanism speeds up the process of sending a NAK to a sender when data is likely going to be lost. When data message 306 is about to be lost due to buffer overflow, the switch-fabric board 101 raises a hardware event via the switch control data path 108. This triggers an event handler that runs on CPU 106. The event handler fetches the contents of data message 306 from the switch-fabric board 101 via the switch control data path 108. The header of data message 306 is parsed, and a fast NAK 307 containing the details to recover data message 306 is sent to the original source of data message 306 running on sender host 201.

The preemptive data retransmission mechanism speeds up the data recovery process by sending retransmission request message(s) 409 to the sender host 201 on behalf of the receiver host 203 when message(s) are dropped due to buffer overflow. The retransmission request may be built from data stored in memory cache 407, which can store data from messages that are received from sender host 201.

The foregoing techniques can be implemented separately or in combination with each other, possibly using common hardware for various operations to efficiently use available resources. The techniques also can be used in combination with other techniques for speeding up recovery of lost data messages.

In some aspects, data loss can be completely or at least largely prevented by sending the early-warning congestion message 208 to the publishing process running on the sender host 201 as soon as a high watermark 205 is reached in the switch's egress buffer 305. The switch-fabric board 101 raises a hardware event via the switch control data path 108 whenever the high-watermark 205 value is reached. The high-watermark 205 value may represent the physical egress buffer 305 being full, or other events, such as TCP/IP window sizes shrinking, or the number of SYNs being received per second during a denial of service attack. These events trigger one or more event handler(s) that runs on CPU 106 that in turn injects a pre-configured packet that contains the early-warning congestion message 208 directly in the switch-fabric board 101 via the switch control data path 108. Injecting the pre-configured packet directly into the switch-fabric board 101 significantly reduces the latency of the early-warning congestion message 208.

The pre-configured data format for early-warning congestion message 208 will vary depending on the underlying traffic and type of event. The packet may be pre-configured to already contain a multicast address destination previously associated with a middleware topic or data path. The publishing process or any other monitoring application may or may not subscribe to this data. A pre-configured packet that contains the early-warning congestion message 208 may also be tagged as a high-priority message to help the packet bypasses other traffic (e.g. using a high CoS rank, or a high-priority VLAN tag).

In some aspects, the switch-fabric board 101 raises a hardware event via the switch control data path 108 when certain events occur. Examples of such events include but are not limited to the switch's egress buffer 305 emptying below the low-watermark 204, the TCP/IP window size reaching a long-running average size, or a number of retransmissions reducing, and a number of SYNs normalizing. This hardware event may trigger an event handler that runs on CPU 106 that in turn injects a pre-configured packet that contains the early-warning congestion message 208 with a clear flag for the relevant event, indicating that the egress buffer 305 is ready to receive more data. If no subsequent data arrives from the send host 201 within a period of time x, the early-warning congestion message 208 with a clear flag may be re-sent first at time Tx, then at T2x, then at T4x, doubling until time Ty (where y>x) is reached, or until data arrives. Thereafter, if no data arrives, the early-warning congestion message 208 with a clear flag may be sent every Ty interval until data arrives. In some aspects, retransmission of the early-warning congestion message 208 with a clear flag can be disabled, for example by setting Tx to 0.

In some preferred aspects, the switch-fabric board 101 is capable of quickly generating events at high watermark 205 and low watermark 204 when egress buffer 305 fills up or drains, or TCP/IP window sizes change, or the number of retransmissions change, or the number of SYNs changes. The event handler(s) also are able to be triggered quickly enough to prevent loss, increased congestion, or denial of service attacks. The switch control data path 108 is able to carry data from switch-fabric board 101 to CPU 106 at a data rate of 10 Gbits/sec or more. Similarly, CPU 106 has enough power to consume data from switch control data path 108 at a rate of 10 Gbits/sec or more.

In these aspects, switch-fabric board 101 is able to copy data message 306 to CPU 106 via the switch control data path 108 before data message 306 is lost. Switch-fabric board 101 is able to cope with packet sizes ranging from 1 byte to several kilobytes. The latency of the switch control data path 108 is lower than the lowest latency of contemporary network interface cards (currently 2.5 us).

Aspects of the present technology can be implemented in many ways, including hardware, firmware, software, or some combination thereof. In one example, the event handlers that handle the transmission of early-warning congestion message 208, the transmission of fast NAK 307, the storage of data message 306 in memory cache 407, and the transmission of the preemptive resend message 409, may be written in the C or assembly languages. The event handlers may either handle the events immediately (if there are relatively few events), or may defer them to a separate soft event handler if the volume of events increases. The code for the events should be fully preemptive and thread safe. The code also should be capable of running in parallel across multiple CPUs (e.g. both on CPUs 106 and 107, or in either CPU). The event handler may be implemented as a “top half” Linux event handler that is part of a driver, or may also run in ‘bare metal’ mode without the need of an operating system.

When running in bare metal mode, the whole or part of CPU 106 (or 107) and its attached memory may be dedicated to running the event handler code.

An alternative solution is for the event handlers to be run inside of a network processor or FPGA chip running on mezzanine boards 102 or 103. These boards would be able to either use switch control data path 108, or one of the direct connections between mezzanine boards 102 or 103 and the switch-fabric board 101. If running in an FPGA, the event handler code may also be written in Register Transfer Languages (RTLs) such as Verilog or VHDL.

According to aspects of the present technology, the preemptive resend message 409's contents should differ depending on the nature of the traffic. For example, the contents may differ depending on whether the traffic is TCP/IP or reliable UDP unicast or multicast. If the traffic is TCP/IP, preemptive message 409 should be a fast retransmit message sent on behalf of the original sender. If the traffic is reliable UDP unicast or multicast, the data should conform to the relevant protocol's semantics, and where appropriate, preemptive message 409 will have a retransmission flag.

Appliance 100 may be implemented as a 1 or 2 rack Unit appliance with 24 external 10 Gbit ports, 24 internal 10 Gbit ports that can be used by mezzanine cards 102 and 103, and 6 external 40 GB ports that may be used to connect two Appliances 100 together, or used to connect to higher-bandwidth connections to sender host 201 or receiver host 203. Data path 109 may be implemented as two 40 or 56 Gbit ethernet or infiniband connectors (or higher) that may be used to connect to external data streams, bypassing switch-fabric board 101, or to also interconnect appliances 100 together in a fault-tolerant fashion. Mezzanine cards 102 and 103 may either have connectivity to just data bus 104 or to both data bus 104 and switch-fabric board 101. Data bus 104 may be implemented as a PCIe Gen 3 bus (or faster spec if available). CPUs 106 and 107 may be implemented as CPUs with an on-board memory controller and PCIe Gen3 bus (or faster spec if available). Lastly, switch-fabric board 101 may be implemented as a PCIe Gen 3 (or faster spec if available) card with 6 to 8 external QSFP+slots, as well as any required number of internal slots.

Switch-fabric board 101 may also be exposed to applications running on CPUs 106 and 107 as a network card. By sending and receiving data to and from switch control data path 108, applications may inject their own traffic directly to Switch-fabric board 101 without the need intermediate mezzanine cards 102 and 103.

Different hardware than that described above may be used to implement aspects of the subject technology.

The advantages of the present technology may also include, without limitation, faster recovery from lost reliable multicast or unicast traffic. By using the fast NAK recovery, data retransmission, and early-warning congestion mechanisms, latency sensitive applications can either prevent loss from occurring, or significantly reduce the time it takes for lost data to be recovered when compared to normal hardware pause mechanisms available in prior-art. Many currently available applications do not propagate hardware pauses to actual sending applications. Instead, the hardware pauses only cause network cards to stopping sending data. When using protocols such as UDP, the sending applications are unaware of pauses and keep on sending data, which simply gets discarded before ever leaving the server. Some aspects of the present technology address these issues and can significantly reduce the number of stale messages in the system, allowing applications to only send the latest data available without overwhelming receivers. This can also significantly reduce the burden on senders.

The advantages of the present technology may further include, without limitation, the ability to quickly monitor, diagnose, and build self-healing applications. With early-warning congestion message 208, monitoring applications can receive events that help support staff quickly diagnose problems without the need of a separate tapping or packet sniffing infrastructure. Senders can also subscribe to the early-warning messages, and throttle back their data until receivers are ready to consume the data. Prior art currently handles loss events with counter increments, or at best with SNMP traps, which are maintained by SNMP daemons that are too slow to proactively react to events.

Different aspects and embodiments of the subject technology may exhibit some, all, or none of the foregoing advantages, and may exhibit other advantages as well.

In broad embodiment, aspects of the subject technology include a hardware appliance that can host a number of different data-centric applications whilst significantly improving recovery and prevention of lost data and diagnosis of network issues.

While the foregoing written description of the technology enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Furthermore, the invention is in no way limited to the specifics of any particular embodiments and examples disclosed herein. For example, the terms “preferably,” “example,” “aspect,” “embodiment,” and the like in the foregoing description denote features that are preferable but not essential to include in embodiments of the invention.

What is claimed is:

1. A data transfer mechanism, comprising:
at least one data buffer through which messages are sent from a message sender to a message receiver;
a preemptive recovery mechanism; and
a preemptive retransmission mechanism;
the preemptive recovery mechanism and the preemptive retransmission mechanism including at least portions of a control data path, an event handler, a processor, and a cache;
wherein the preemptive recovery mechanism sends an early warning message to the message sender independently of the message receiver upon detection that the data buffer is nearing overflow; and
wherein the preemptive retransmission mechanism sends a retransmission request on behalf of the message receiver upon detection that the receiver's data buffer has overflowed.

2. The data transfer mechanism as in claim 1, wherein the event handler cause the processor to effect sending of the early warning message to the message sender.

3. The data transfer mechanism as in claim 1, wherein the event handler cause the processor to effect sending of a pre-emptive retransmission request on behalf of the receiver to the message sender.

4. The data transfer mechanism as in claim 1, wherein the processor comprise one or more network processors.

5. The data transfer mechanism as in claim 4, wherein the event handler comprise at least portions of the one or more network processors.

6. The data transfer mechanism as in claim 1, wherein the event handler comprise at least portions of one or more field programmable gate arrays.

7. The data transfer mechanism as in claim 1, wherein the preemptive recovery mechanism and the preemptive retransmission mechanism comprise mezzanine boards.

8. The data transfer mechanism as in claim 1, wherein the event handler detect that the data buffer is nearing overflow based on a watermark.

9. The data transfer mechanism as in claim 8, wherein the watermark comprises a physical size of the data buffer.

10. The data transfer mechanism as in claim 8, wherein the watermark comprises a TCP/IP window size or a number of TCP/IP retransmissions.

11. The data transfer mechanism as in claim 8, wherein the watermark comprises a number of connection requests coming from the message sender.

12. A data transfer mechanism, comprising:
at least one data buffer through which messages are sent from a message sender to a message receiver; and
a preemptive recovery mechanism including at least portions of a control data path, an event handler, and a processor;
wherein the preemptive recovery mechanism sends an early warning message to the message sender independently of the message receiver upon detection that the data buffer is nearing overflow.

13. The data transfer mechanism as in claim 12, wherein the event handler cause the processor to effect sending of the early warning message to the message sender.

14. The data transfer mechanism as in claim 12, wherein the event handler detect that the data buffer is nearing overflow based on a watermark.

15. The data transfer mechanism as in claim 14, wherein the watermark comprises a physical size of the data buffer.

16. The data transfer mechanism as in claim 14, wherein the watermark comprises a TCP/IP window size or a number of TCP/IP retransmissions.

17. The data transfer mechanism as in claim 14, wherein the watermark comprises a number of connection requests coming from the message sender.

18. A data transfer mechanism, comprising:
at least one data buffer through which messages are sent from a message sender to a message receiver; and
a preemptive retransmission mechanism including at least portions of a control data path, an event handler, a processor, and a cache;
wherein the preemptive retransmission mechanism sends a lost one of the data messages from the cache independently of the message receiver upon detection that the data buffer has overflowed.

19. The data transfer mechanism as in claim 18, wherein the event handler cause the processor to effect sending of the lost one of the messages from the cache to the message sender.
